(19) United States
(12) Patent Application Publication
(10) Pub. No.: US 2024/0041264 A1
(43) Pub. Date: Feb. 8, 2024

(54) Tongs

(71) Applicant: Kikkerland Design, Inc., New York, NY (US)

(72) Inventor: Stacey Householder, New York, NY (US)

(21) Appl. No.: 17/883,297

(22) Filed: Aug. 8, 2022

(51) Int. Cl. A47J 43/28

(52) U.S. Cl. CPC A47J 43/283; A47G 2200/106

(57) ABSTRACT

Tongs includes complementary first and second elongated arms each with a handle end and grasping heads. The arms are pivotally connected so that the arms can rotate between an open and a closed position. The handle ends are held in place by one or more magnets in the open position and the grasping heads form a Y-shaped configuration. No tension springs or other biasing mechanism are needed. In use, grasping ends are pressed towards each other to overcome the attractive force so the tongs are in the closed position. Tongs employs cleaning and utensil implements on the grasping ends. Microfibers on the grasping heads can be used for cleaning applications. The tongs are particularly suited for light household applications and as kitchen utensils.

### FIELD OF THE INVENTION

The present invention generally relates to tongs for household applications and particularly to tongs consisting of a pair of pivotally mounted elongated arms that are held by magnets in the open position.

### BACKGROUND OF THE INVENTION

Tongs are typically used to grab, manipulate and pick up pieces of food, toss a salad, and assist with grilling. Most tongs include a pair of long arms that are pivotally engaged with each other at one end. The tongs can include a spring mechanism to maintain the arms in a biased open position. In use, the arms are pressed together to grasp articles. Tongs can also include a locking mechanism to maintain the arms in a fixed position such as for storage. Current tongs tend to be bulky and are difficult to thoroughly clean.

### SUMMARY OF THE INVENTION

The present invention is based, in part, on the development of tongs, that includes complementary first and second elongated arms each with grasping heads and handle ends that contain one or more magnets. The term “tongs” is also interchangeably referred to as a “pair of tongs”. The first elongated arm is pivotally mounted to the second elongated arm and the handle ends are held in place preferably solely by the attractive force of the magnet(s) while the tongs are in an open position. In use, the grasping ends are pressed to overcome the magnetic force so the tongs are in the closed position. No tension springs or other biasing mechanism are needed. In one embodiment of the invention, wooden tongs employ microfibers on the grasping heads for cleaning applications. The tongs are particularly suited for light household applications and as kitchen utensils.

### BRIEF DESCRIPTION OF THE DRAWINGS

FIG. 1 is a perspective view of the tongs in a disassembled or exploded view;

FIG. 2 is a perspective view of the tongs in an assembled open position;

FIG. 3 is a side view of the tongs in the assembled open position;

FIG. 4 is a cross-sectional view taken along line 4-4 in FIG. 3;

FIG. 5 is a cross-sectional view taken along line 5-5 in FIG. 3;

FIG. 6 is a side view of the tongs in the assembled closed position;

FIGS. 7 and 8 are side views of a second embodiment of tongs in the open and closed positions, respectively;

FIG. 9 depicts grasping ends with serrated edges;

FIG. 10 depicts grasping ends with broad flat shapes (spatula); and

FIG. 11 depicts grasping ends with round contours and perforations.

### DETAILED DESCRIPTION OF THE PREFERRED EMBODIMENTS

As shown in FIGS. 1, 2, 3, 4, 5 and 6, tongs 40 includes a first arm 2 having a grasping end (i.e., distal end) that consists of a grasping head or grasping member 6 and a handle end 4 (i.e., proximal end) that includes a permanent magnet 12 secured or embedded therein. The inner surface of first arm 2 at the proximal end has a planar surface.

A mat or pad 10 is secured to the inner surface 8 of grasping head 6. The mat or pad is preferably made of fabric, cloth, sponge or other soft liquid absorbing natural or synthetic material which removes household dirt and debris. A preferred liquid absorbing material is made from synthetic microfibers. A microfiber has a denier value of less than 1. “Denier” is the term used to define the diameter or fineness of a continuous or filament fiber. Microfibers are commercially available and are described, for example, in U.S. Pat. No. 7,743,456 to McDonnell which is incorporated herein by reference. A preferred microfiber is made of polyester. Arcuate groove or slot 14 is formed on the inner surface of the first arm 2 in a direction that is transverse to the axis of the elongated first arm 2. The inner surface of first arm 2 at the proximal end below the slot 14 is planar. The slot 14 separates the proximal end from the distal end of first arm 2.

Tongs 40 also includes a second arm 16 having a grasping end (i.e., distal end) that consists of a grasping head or grasping member 20 and handle end 18 (i.e., proximal end) that includes a permanent magnet 30 (FIG. 30) secured or embedded therein.

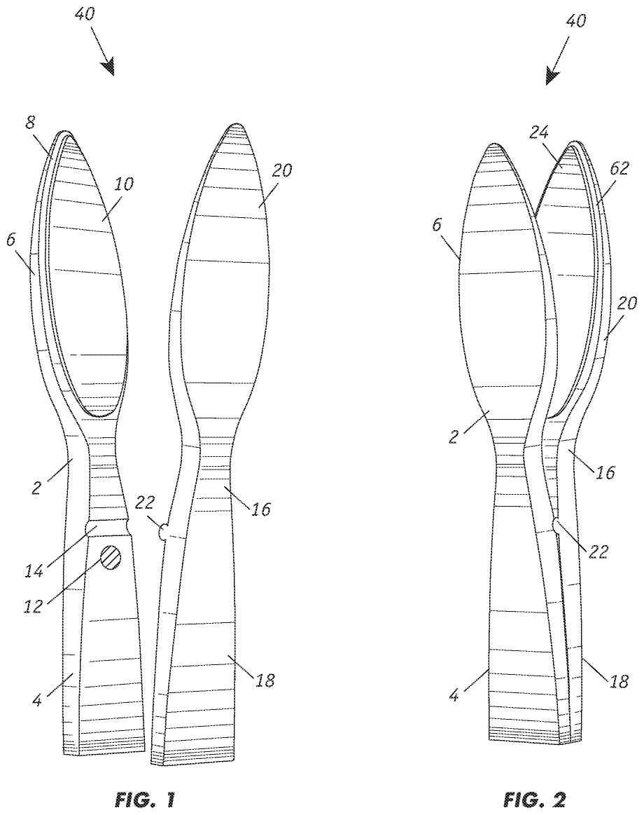

A mat or pad 24 is secured to the inner surface 62 (FIG. 2) of grasping head 20. A grooved projection or rail member 22 is formed on the surface of the inner surface a direction that is transverse to the axis of the elongated second arm 16. The dimensions of the convex contour allow rail member 22 to be slidably engaged to the arcuate slot 14 of the first arm 2. The member 22 is pivotally mounted on the arcuate slot 14 and the member serves as a fulcrum and a pivot axis for the first arm 2. The inner surface of second arm 16 at the proximal end below the member 22 is planar. The rail member 22 separates the proximal end from the distal end of second arm 16.

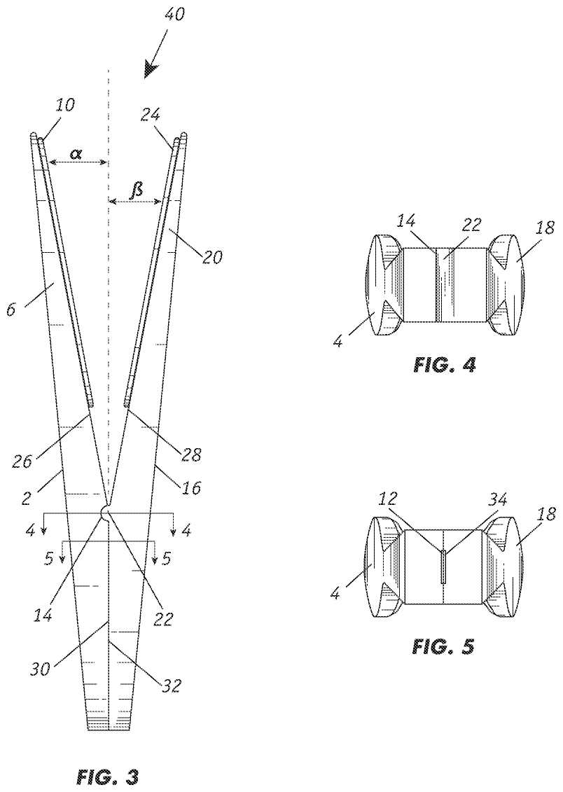

As shown in FIGS. 3, 4 and 5 with tongs 40 in the open position, the inner surface 30 of the proximal end of first arm 2 is flush with the inner surface 32 of the proximal end of second arm 16. The inner surface 26 of the distal end of first arm 2 is not planar to inner surface 30 of the proximal end of the first arm 2 and the inner surface 28 of the distal end of second arm 16 is not planar to inner surface 32 of the proximal end of the second arm 16. In this fashion, grasping ends 6 and 20 defined a Y-shaped configuration wherein the angle α between mat 10 and the central vertical axis of the Y-shaped is typically 1 to 15 degrees and preferably from 5 to 10 degrees and the angle β between mat 24 and the central vertical axis is typically 1 to 15 degrees and preferably from 5 to 10 degrees. Preferably the two angles are the same.

Permanent magnet 12 which is incorporated within first arm 2 is attracted to permanent magnet 34 which is incorporated within second arm 16. The attraction keeps the first and second arms together. Magnet 12 has a planar surface which is flush with the inner surface 30 of the proximal end of first arm 2 and magnet 34 has a planar surface which is flush with the inner surface 32 of the proximal end of second arm 16. Alternatively, one of the magnets 12 or 34 can be replaced with a ferromagnetic material which the remaining permanent magnet is attracted to. Suitable ferromagnetic materials include steel.

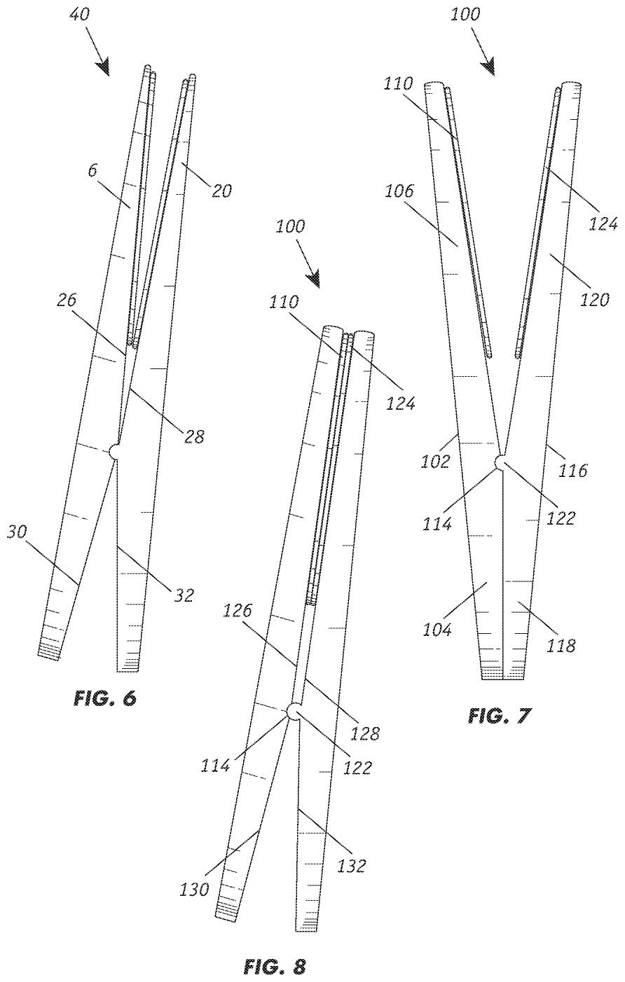

In operation, a person presses the grasping ends 6, 20 of the tongs with sufficient force to pull the magnets 12, 34 apart so that inner surfaces 30, 32 separate and mats 10 and 24 come into contact with materials to be cleaned as shown in FIG. 6. For instance, when the mats are made of microfibers, tongs 40 can be used to clean house plants to remove dust and other debris from the leaves. After using the tongs, pressing the handle ends 4, 18 (FIG. 2) returns the first and second arms 2, 16 of the tongs 40 back to the open position with the magnets engaged with each other and maintaining the inner surfaces 30, 32 pressed together as shown in FIG. 3. The first and second arms 2, 16 can be readily pull apart and detached for cleaning such as in a dish washer. The tongs can be made of wood, hard plastic, and/or metal, such as stainless steel.

In one configuration, tongs 40 includes a wooden first arm 2 with an arcuate groove or slot 14 and a wooden second arm 16 with a grooved projection or rail member 22. The rail member is created by carving or cutting the wood so that each of the first arm 2 and second arm 16 is constructed as an integral or unitary unit with permanent magnets disposed at the proximal end of each handle. The wooden tongs 40 can have grasping heads 6, 20 that are entirely wooden, so the tongs is made solely of wood other than the magnet(s) or ferromagnetic material. Alternatively, one or both of the grasping heads can have a cleaning or utensil implement secured thereto. A preferred cleaning implement is made from microfibers.

FIGS. 7 and 8 illustrate another embodiment wherein tongs 100 includes a first arm 102 with a grasping head 106 and a handle end 104 that has a permanent magnet (not shown) embedded therein. The inner surface 130 of first arm 102 at the proximal end has a planar surface. A mat 110 is secured to the inner surface of grasping head 106. Transverse arcuate groove or slot 114 is formed on the inner surface of the first arm 102 and the inner surface 130 of first arm 102 at the proximal end below the slot 114 is planar.

Tongs 100 further includes a second arm 116 with a grasping head 120 and handle end 118 that includes a permanent magnet (not shown) embedded therein. A mat 124 is secured to the inner surface grasping head 120. A transverse grooved projection or rail member 122 is formed on the surface of the inner surface of second arm 116. The dimensions of the convex contour allow rail member 122 to be slidably engaged to the arcuate slot 114 of the first arm 102. Member 122 is pivotally mounted on the arcuate slot 114 and member 122 serves as a fulcrum and a pivot axis for the first arm 102. The inner surface 132 of second arm 116 at the proximal end below the member 122 is planar.

The inner surface 126 of the distal end of first arm 102 is not planar to inner surface 130 of the proximal end of the first arm 102 and the inner surface 128 of the distal end of second arm 116 is not planar to inner surface 132 of the proximal end of the second arm 116.

In use, pressing the grasping ends 116, 120 with sufficient force pulls the magnets apart so that inner surfaces 130, 132 separate and mats 110 and 124 come together as shown in FIG. 8. The movement of arms 102, 116 of tongs 100 is essentially the same as those of tongs 40 (FIGS. 3 and 6), however, the configurations of the rail member 122 and arcuate slot 114 permit arms 102 and 116 to maneuver closer together. The concavity of arcuate slot 114 has a relatively low depth so that rail 122 can freely rotate over a larger portion of the slot.

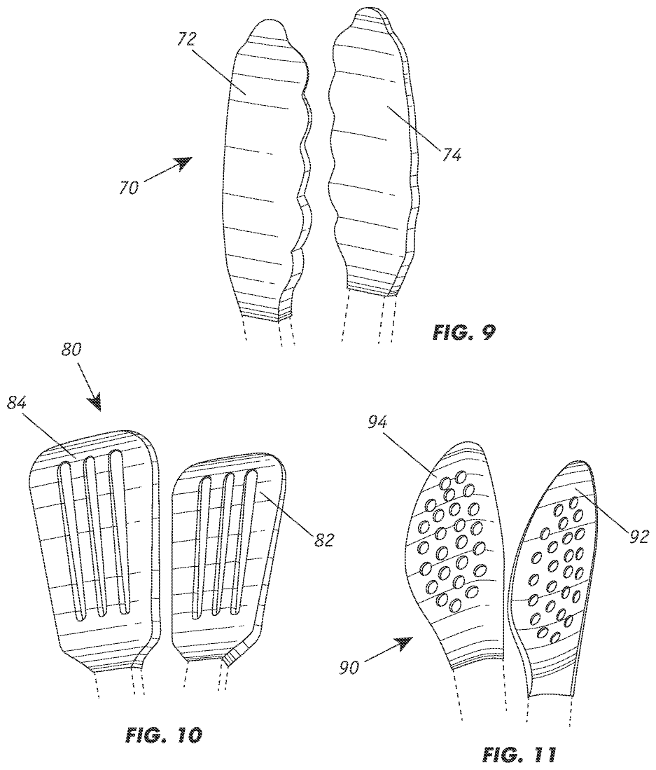

The grasping heads of the tongs can have cleaning and utensil implements of different configurations depending on the particular applications such as for picking up or handling food. For instance, FIG. 9 partially depicts the distal end of tongs 70 comprising a pair of grasping heads 72, 74 each with serrated member edges; FIG. 10 partially depicts tongs 80 comprising a pair of broad flat blade, spatula-shaped grasping heads 82, 84, and FIG. 11 partially depicts tongs 11 comprising a pair of perforated spoon-shaped grasping heads 92, 94. Other examples of grasping heads include implements such as forceps, prongs, forks, and the like. It is understood that the two grasping heads of the tongs can be the same or different implement.

The foregoing has described the principles, preferred embodiments and modes of operation of the present invention. However, the invention should not be construed as being limited to the particular embodiments discussed. Thus, the above-described embodiments should be regarded as illustrative rather than restrictive, and it should be appreciated that variations may be made in those embodiments by workers skilled in the art without departing from the scope of the present invention as defined by the following claims.

What is claimed is:

1. Tongs that comprise:
(a) a first arm having a first elongated member that has a first handle with an inner surface and a first grasping head, wherein the first handle inner surface defines a first handle inner surface plane and the first grasping head has an inner surface that defines a first grasping head inner surface plane that is not co-planar with the first handle inner surface plane and wherein the first elongated member has an arcuate slot;
(b) a second arm having a second elongated member that has a second handle with an inner surface and a second grasping head, wherein the second handle inner surface defines a second handle inner surface plane and the second grasping has an inner surface that defines a second grasping inner surface plane that is not co-planar with the second handle inner surface plane and wherein the second elongated member has a projection that is configured to slidably engage the arcuate slot to allow rotation of the first arm relative to the second arm; and
(c) a magnet that is mounted on at least one of the first handle or the second handle so that the first handle and second handle are magnetically engaged when the first and second arms are in an open position.

2. The tongs of claim 1 wherein the arcuate slot defines a recess in the first elongated member and is formed in a direction that is transverse to that of the first elongated member and wherein the projection has a curved contour that fits into the recess.

3. The tongs of claim 1 wherein the projection is pivotally mounted on the arcuate slot and the projection serves as a fulcrum for the first arm.

4. The tongs of claim 1 wherein the first arm and the second arm define a Y-shaped configuration when the first arm is magnetically engaged to the second arm and the tongs are in an open position.

5. The tongs of claim 1 wherein the first handle has a first magnet incorporated therein and the second handle has a second magnet incorporated therein.

6. The tongs of claim 1 wherein the first grasping head comprises first microfibers secured thereon and the second grasping comprises second microfibers secured thereon such that the first and second microfibers faced each other.

7. The tongs of claim 1 such that when first and second arms are in an open position an inner surface of the first handle inner surface is flush with an inner surface of the second handle.

8. The tongs of claim 1 wherein the first grasping head comprises an implement for handling food and second grasping head comprises an implement for handling food.

9. Tongs that comprise:
(a) a first arm having a first distal grasping end and a first proximal handle end;
(b) a second arm having a second distal grasping end and a second proximal handle end, wherein at least one the first proximal handle end or the second proximal end includes a magnet, and
(c) means for pivotally connecting the first arm to the second arm so that the first arm and second arm are rotatable between an open position and a closed position, wherein the first proximal handle end is engaged to the second proximal handle end when in the open position.

10. The tongs of claim 9 wherein the first distal grasping end and the second distal grasping end define a Y-shaped configuration when in the open position.

11. The tongs of claim 9 wherein the first proximal handle end includes a first magnet and the second proximal handle end includes a second magnet.

12. The tongs of claim 9 wherein first distal grasping end has a first cleaning implement and the second distal grasping end has a second cleaning implement.

13. The tongs of claim 12 wherein the first and second cleaning implements comprise microfibers.

14. The tongs of claim 9 wherein first distal grasping end has a first utensil implement and the second distal grasping end has a second utensil implement.

15. The tongs of claim 9 wherein the first arm and the second arm are detachable.

16. The tongs of claim 9 wherein the first arm and the second arm are made of material that is selected from the group consisting of wood, plastic, metal or combinations thereof.

17. Wooden tongs that comprises:
(a) a wooden first elongated member having a first handle at the proximal end and a first grasping head at the distal end wherein the first elongated member defines an arcuate slot located between the proximal end and the distal end and wherein the first elongated member is an integral unit; and
(b) a wooden second elongated member having a second handle at the proximal end and a second grasping head at the distal end wherein the second elongated member defines a projection that is configured to slidably engage the arcuate slot to allow rotation of the first arm relative to the second arm and wherein the projection is located between the proximal end and the distal end and wherein the second elongated member is an integral unit,
(c) a magnet that is disposed in at least one of the first handle or the second handle so that the first handle and second handle are magnetically engaged when the first and second elongated arms are in an open position.

18. The wooden tongs of claim 17 wherein the first grasping head and the second grasping head form a Y-shaped configuration in the open position.

19. The wooden tongs of claim 17 wherein the first grasping head has first microfibers secured thereto and the second grasping head has second microfibers secured thereto and the first microfibers face the second microfibers.

20. The wooden tongs of claim 17 wherein the first handle has a first magnet and the second handle has a second magnet and the first handle defines a first inner surface and the second handle defines a second inner surface which is flush with the first inner surface when the tongs are in the open position.
